(19) United States
(12) Patent Application Publication
(10) Pub. No.: US 2007/0023088 A1
(43) Pub. Date: Feb. 1, 2007

(54) Fluid Transfer Pump

(75) Inventor: Robert D. Benson, White Bear Lake, MN (US)

Correspondence Address: INSKEEP INTELLECTUAL PROPERTY GROUP, INC, 2281 W. 190TH STREET, SUITE 200, TORRANCE, CA, 90504, US

(73) Assignee: FluidTran, Inc.

(21) Appl. No.: 11/460,895

(22) Filed: Jul. 28, 2006

Related U.S. Application Data
(60) Provisional application No. 60/703,553, filed on Jul. 28, 2005.

(51) Int. Cl. F04B 49/00; F17D 1/00

(52) U.S. Cl. 137/565.11; 137/571

(57) ABSTRACT

A portable fluid transfer method and apparatus for moving a fluid from a source to a destination. The apparatus comprises a pump driven by an air motor, an activating valve, a needle valve for adjusting the flow of air from the air motor, and connections to the source of fluid that allow the fluid to be contained throughout the transfer to the destination.

### CROSS REFERENCE TO RELATED APPLICATIONS

This application claims the benefit of priority from U.S. Provisional Application Ser. No. 60/703,553 filed on Jul. 28, 2005, the contents of which are hereby incorporated by reference.

### BACKGROUND OF THE INVENTION

The present invention relates to a method and apparatus for removing fluid from a drum or bulk storage unit.

Drums that contain fluids such as engine oil come in 55 gallon or totes having at least 100 to 700 gallon capacities, the drums having a bung in one end. The fluid is typically dispensed from the drum by tipping the drum onto a side or by inserting a hose into the drum. Typically, hand-operated valves are employed during such a process and are found to leak after a short period of time. The leaking fluid must be collected into a pan, which thereafter must be emptied into a waste drum for proper environmentally-compliant disposal. Further, employing such a process presents difficultly in getting every last ounce of fluid out of the drum. Since some fluids, for example, aircraft engine oil, may cost as much as $8 dollars per quart or more, it is important not to waste such a fluid.

In addition, tipping the drum onto a side can cause leakage to the environment, fires, and injury to personnel, as the drums may weigh 400 pounds or more. Further, other fluid storage units, such as totes and/or other bulk storage tanks, may or may not be easily mobile.

It is necessary to transfer the fluid to a secure container in a manner that prevents fires, leakage to the environment, contamination to the fluid and possible injury to personnel.

There is a need for an apparatus that protects the environment, protects the fluid it is transferring and protects personnel operating the transfer system.

### SUMMARY OF THE INVENTION

An apparatus for portably transferring a fluid from a source to a destination comprising a housing of compact construction, comprising an air motor, a pump, a push button valve, a needle valve, a fluid inlet and a fluid outlet.

A principal object and advantage of the present invention is that it allows fluid to be transferred from a drum, tote and/or bulk storage tank or unit to a smaller container.

Another principal object and advantage of the present invention is that the pump can be driven by an air motor, reducing and eliminating the possibility of a fire or explosion from the fluid being transferred.

Another principal object and advantage of the present invention is that it prevents contamination of the environment and eliminates spilled fluid.

Another principal object and advantage of the present invention is that it reduces the likelihood of injury to personnel caused by tipping heavy drums.

### BRIEF DESCRIPTION OF DRAWINGS

FIG. 1 is a schematic illustration of one embodiment of the present invention.

### DETAILED DESCRIPTION OF THE PREFERRED EMBODIMENT

The present invention is generally shown in the Figures as reference numeral 10.

The present apparatus 10 comprises an air motor 12 which is driven by a source of compressed air 14 through a fitting 15. A needle valve 16 or similar mechanism controls the rate of flow of compressed air into the air motor, thus modifying the speed of the air motor.

The air motor 12 drives a pump 18, for example, a gear pump. One of ordinary skill in the art would understand that various pumps could be used and are contemplated for use in the present invention.

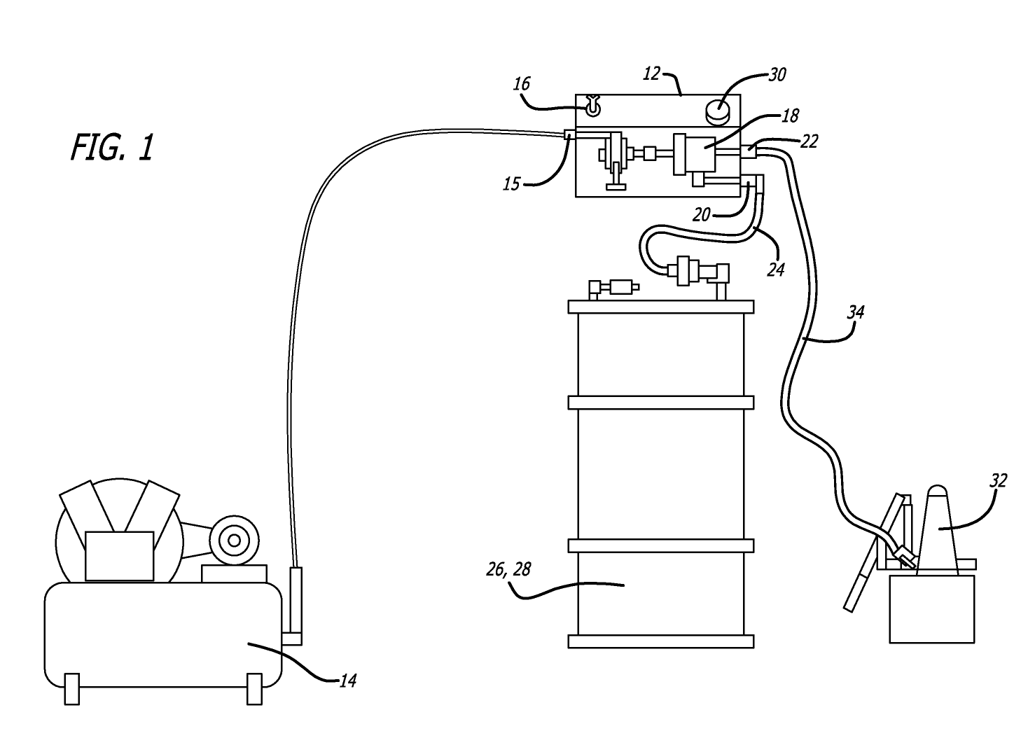

Referring to FIG. 1, the pump 18 has an inlet 20 and an outlet 22. Attached to the inlet 20 by suitable piping or hose 24 is a source of fluid 26 which is typically, for example, a drum 28. Although not shown, one of ordinary skill in the art would know that a drum 28 has a bung aperture in its top lid, to which the piping or hose 24 is attached for removal of fluid from the drum 28.

Additional sources of fluid 26 contemplated for use in the present invention may include any variety of bulk storage sources or containers, including but not limited to, totes and bulk storage tanks or units, such as portable or stationary tanks.

Driven by the air motor, and controlled by an activation valve or button 30, the pump 18 transfers fluid, at a rate controllable by the needle valve 16, into a container 32 through a suitable hose 34.

To prepare the apparatus for operation, the source of compressed air 14 is connected to the fitting 15. The drum 28 is connected to the inlet 20. The valve or button 30 is activated and the needle valve 16 is adjusted to obtain the required flow rate, filling the container 32.

The apparatus may be mounted on a wall or may simply be placed on top of the drum 28 or remote location, or can be hand-carried to a fluid transfer site.

The apparatus 10 is portable, typically having dimensions of, for example, about 14½ inches by 9⅜ inches. When the appropriate amount of fluid has been transferred to the container 32, the valve or button 30 is closed, and the source of compressed air 14 and the drum 28 are disconnected.

What is claimed is:

1. An apparatus for portably transferring a fluid from a source of fluid to a destination, comprising a housing of compact construction comprising an air motor, a pump, a push button valve, a needle valve, a fluid inlet, and a fluid outlet.

2. The apparatus of claim 1 wherein the fluid comprises engine oil.

3. The apparatus of claim 1 wherein the source of fluid is a drum.

4. The apparatus of claim 1 wherein the pump is a gear pump.

5. The apparatus of claim 1 wherein the source of fluid is a tote.

6. The apparatus of claim 1 wherein the destination comprises a portable fluid receptacle.

7. The apparatus of claim 1, wherein the apparatus is wall-mounted.

8. A method of transferring fluid from a source to a destination, comprising the steps of:
providing a fluid transfer source that is operably connected with a portable pump system; and
providing a fluid transfer destination that is operably connected with said portable pump system;
activating said portable pump system in a manner sufficient to transfer substantially all of the fluid from said source to said destination.

9. The method of claim 8, wherein providing a fluid transfer source comprises providing a fluid-containing drum.

10. The method of claim 8, wherein providing a fluid transfer destination comprises providing a transportable fluid container.

11. The method of claim 8, wherein providing a transportable fluid container comprises providing an engine oil container.

12. The method of claim 8, wherein providing a transportable fluid container comprises providing a hydraulic oil container.

13. The method of claim 8, wherein providing a fluid transfer source that is operably connected with a portable pump system comprises providing a fluid transfer source that is operably connected with a portable pump system comprising an air motor, a pump, an activation valve, a valve for restricting fluid flow, a fluid inlet and a fluid outlet.

14. The method of claim 13, wherein providing a fluid transfer source that is operably connected with a system comprising a pump comprises providing a fluid transfer source that is operably connected with a system comprising a gear pump.

15. The method of claim 8, wherein activating said portable pump system in a manner sufficient to transfer substantially all of the fluid from said source to said destination comprises activating said portable pump system in a closed system.

16. A method of preventing environmental contamination by spilled fluid comprising:
providing a fluid source that is operably connected with a fluid destination;
transferring the contents of said fluid source to said fluid destination;
wherein said contents are prevented from exposure to the environment.

17. The method of claim 16, wherein transferring said contents of said fluid source to said fluid destination comprises transferring an environmental contaminant from said fluid source to said fluid destination.

18. The method of claim 17, wherein transferring an environmental contaminant from said fluid source to said fluid destination comprises transferring oil from an oil drum to a transportable oil container.

19. The method of claim 16, wherein transferring said contents of said fluid source to said fluid destination comprises portably transferring said contents of said fluid source to said fluid destination.

20. The method of claim 16, wherein transferring the contents of said fluid source to said fluid destination comprises transferring the contents through a closed containment system.
